(19) United States
(12) Patent Application Publication
(10) Pub. No.: US 2012/0152420 A1
(43) Pub. Date: Jun. 21, 2012

(54) Tire with Protective Appliques

(75) Inventors: Arnaud Larregain, Thiers (FR); Olivier Muhlhoff, Chateaugay (FR)

(73) Assignees: Societe de Technologie Michelin, Clermont-Ferrand (FR); Michelin Recherche et Technique S.A., Granges-Paccot (CH)

(21) Appl. No.: 13/257,475

(22) PCT Filed: Mar. 17, 2010
(86) PCT No.: PCT/EP10/53481

§ 371 Date: Mar. 12, 2012

Related U.S. Application Data
(60) Provisional application No. 61/221,357, filed on Jun. 29, 2009.

(30) Foreign Application Priority Data
Mar. 18, 2009 (FR) 0951707

(51) Int. Cl. B60C 19/00; B32B 37/12; B32B 37/14

(52) U.S. Cl. 152/209.1; 156/293

(57) ABSTRACT

A tire (10) comprising a tread (40) provided with a rolling surface, at least one recess (90) being formed in the tread, which recess opens onto the rolling surface, the recess being delimited by a bottom wall and one single side wall, the tire also comprising at least one appliqué (100; 1001-1002), and the appliqué being inserted into the recess and fixed by means of an adhesive (110) to at least a portion of said bottom or side wall of the recess. The invention also concerns a method and a kit for making a tire more resistant to external aggression.

### RELATED APPLICATIONS

This is a U.S. National Phase Application under 35 USC 371 of International Application PCT/EP2010/053481, filed on Mar. 17, 2010.

This application claims the priority of French patent application no. 09/51707 filed Mar. 18, 2009 and U.S. provisional patent application No. 61/221,357 filed Jun. 29, 2009, the entire content of both of which is hereby incorporated by reference.

### FIELD OF THE INVENTION

The present invention relates to tires for vehicles. It relates more particularly to tires having a protective appliqué on their outer surface, and to methods for protecting the recesses of tires from external aggression of various kinds.

### BACKGROUND OF THE INVENTION

A tire is subjected to a great amount of external aggression during its life. This includes not only mechanical aggression, resulting particularly in cuts and even perforations, but also chemical attack, due in particular to ultraviolet radiation and the presence of ozone in the atmosphere.

The tread of a tire is particularly affected by mechanical aggression, because it is its rolling surface that comes into contact with the ground on which the tire is rolling. In particular, the tread may be damaged from sharp objects over which the tire may roll. The tread is also affected by chemical attack, but the fact that the tread wears down means that damage caused by ultraviolet radiation and ozone action has no lasting effect, at least not on the rubber forming the rolling surface, if the tire is used regularly.

The situation is different, however, in the case of those parts of the tread which are not subjected to wear and yet are part of the outer surface of the tread, that is to say the inner surface or bottom of the recesses and grooves that open onto the rolling surface. These parts of the tread are subjected to mechanical and chemical aggression and can be damaged by the prolonged effect of this aggression. It is thus not uncommon to find cracks appearing in the bottoms of the grooves of tires.

The bottoms of grooves and other recesses could be reinforced by using more resistant materials in these locations of the tread, but this approach would increase the manufacturing cost (if the entire tread were made of these materials) or would make the manufacturing process more complex (if composite treads were adopted). Another disadvantage linked with this “upstream” approach is that it would not allow temporal adaptation of the tire to specific conditions of use.

### SUMMARY OF THE INVENTION

It is an object of the present invention to provide tire users with a simple method, within the capabilities of any end user who has some basic tools, for protecting the tire against external aggression.

This object is achieved in accordance with one aspect of the present invention directed to a method for making a tire more resistant to external aggression, the tire comprising a tread having a rolling surface and at least one recess opening onto the rolling surface, the recess being delimited by a bottom wall and one single side wall, and the method comprising the following steps:
(A) inserting an appliqué into the recess;
(B) fixing the appliqué by means of an adhesive to at least a portion of said bottom or side wall of the recess.

The method according to the invention results in a tire that is more resistant to external aggression, because the presence of the appliqué has the effect of:
reducing the risk of cuts or perforations, and/or
absorbing at least some of the ultraviolet radiation before it reaches the surface which it covers, and/or
preventing ozone from coming into contact with this surface.

The method is within the capabilities of any user of the tire who has some basic tools.

It has the advantage of allowing the end user to adapt the tire to specific conditions of use. To take an example, a cyclist can instantaneously adapt his or her mountain bike tires for terrain covered with acacia thorns or sharp flints, without having to resort to heavier or more expensive tires which could become a drawback on less aggressive terrain.

It should be noted that the bottom wall and the side wall are not necessarily distinct from each other and can be merged. For instance, in a recess of semi-spherical shape, the same wall forms both the bottom and side wall.

The fact that the recesses under consideration have only one side wall excludes grooves, which have two side walls, from being considered to be recesses in the above sense.

Another aspect of the invention relates to a tire comprising a tread provided with a rolling surface, at least one recess being formed in the tread, which recess opens onto the rolling surface, the recess being delimited by a bottom wall and one single side wall (which walls, as stated above, can be merged), the tire also comprising at least one appliqué, and the appliqué being inserted into the recess and fixed by means of an adhesive to at least a portion of said bottom or side wall of the recess.

The applicant has found that, surprisingly and contrary to expectations, an appliqué bonded adhesively into such a recess in the tire exhibits good resistance to the stresses experienced by the tread.

According to one advantageous embodiment, the appliqué is fixed to at least a portion of said bottom wall. It preferably covers at least 80% of the surface of the bottom wall.

The life of the appliqué is longest when the recess is deep enough for the appliqué to be entirely radially inside of the rolling surface, i.e. when the radially outermost points of the appliqué are radially inside of the rolling surface of the tread.

According to one preferential embodiment, the side wall of the recess is a closed surface. Within the present document, the side wall of a recess is considered to be a “closed surface” if its intersection with the rolling surface of the tread, when the tire is new, is a closed curve, i.e. a curve with no endpoints. By contrast, the side wall of a recess is considered to be an “open surface” if its intersection with the rolling surface of the tread, when the tire is new, is an open curve, i.e. a curve with two endpoints. If the side wall of the recess is a closed surface, the appliqué is particularly well protected from being detached from the tire.

When determining whether the side wall of the recess is a closed surface, sipes opening into the recess are to be disregarded. As a matter of fact, when the side wall of the recess is a closed surface and when the radially outermost points of the appliqué are radially inside of the rolling surface of the tread, it is advantageous to provide sipes through which the air imprisoned within the volume of the recess, when the rolling surface surrounding the recess comes into contact with the ground on which the tire is rolling, can escape. This is advantageous in particular in view of the noise generated by the tire when it is rolling.

According to one preferential embodiment, the side wall of the recess is a quasi-closed surface. The side wall of a recess is considered to be a “quasi-closed surface” if its intersection with the rolling surface of the tread, when the tire is new, is an open curve, i.e. a curve with two endpoints C1 and C2, and if the length of the straight line L connecting endpoints C1 and C2 is smaller than the maximum distance between any two points of curve C, measured parallelly to said straight line L. A recess the side wall of which is quasi-closed still protects the appliqué because the narrowing of the side wall towards the lateral opening of the recess hinders the appliqué from being displaced into the opening.

Preferably, the length of the straight line L connecting endpoints C1 and C2 is smaller than 50% of the maximum distance between any two points of curve C, measured parallelly to said straight line L, and even more preferably, smaller than 20% of the maximum distance between any two points of curve C, measured parallelly to said straight line L.

The appliqué may be black, making it almost invisible to the naked eye on the tread, but it may also have at least a portion of a color other than black, this portion being visible from a viewpoint outside of the tread and facing the appliqué. Decorative effects can thus be obtained in addition to the protective effect.

Those skilled in the art will understand that the reference to the color “other than black” has been chosen because tire treads are almost invariably black. If this embodiment of the invention was to be implemented on a tread having a certain color other than black, the corresponding appliqué would have to comprise at least one portion of a color other than this color.

Another aspect of the invention relates to a kit for making a tire more resistant to external aggression according to the method disclosed herein, the kit comprising at least one appliqué designed to be inserted into a recess in the tire tread, which recess opens onto the rolling surface, the recess being delimited by a bottom wall and a side wall, wherein the kit also comprises a suitable adhesive for fixing the appliqué to at least a portion of said bottom or side wall of the recess.

The kit preferably also comprises a set of instructions describing steps (A) and (B) of the method according to an embodiment of the invention mentioned above.

### BRIEF DESCRIPTION OF THE DRAWINGS

FIGS. 1 and 2 show diagrammatically a prior-art motorcycle tire.

FIG. 3 shows diagrammatically, in radial section, a prior-art motorcycle tire.

FIG. 4 shows diagrammatically, in a top view, the tread of a tire according to embodiments of the invention.

FIG. 5 shows diagrammatically, in radial section, part of the tire in FIG. 4.

FIGS. 6 and 7 show diagrammatically various appliqués designed to be used in a method according to embodiments of the invention.

FIG. 8 shows diagrammatically a tire according to an embodiment of the invention.

FIG. 9 is a perspective view of a tread block comprising a recess according to an embodiment of the invention.

FIGS. 10 and 11 illustrate a recess having a side wall that is a quasi-closed surface.

FIG. 12 shows diagrammatically, in circumferential section, part of a tire according to an embodiment of the invention.

### DETAILED DESCRIPTION OF THE DRAWINGS

When the term “radial” is used, it is important to distinguish between several different uses of the word among those skilled in the art. Firstly, the expression refers to a radius of the tire. It is in this sense that a point P1 is said to be “radially inside” of a point P2 if it is nearer than point P2 to the axis of rotation of the tire. Conversely, a point P3 is said to be “radially outside” of a point P4 if it is further than point P4 from the axis of rotation of the tire. “Radially inwards (or outwards)” means towards diminishing (or increasing) radii. This meaning of the term also applies when radial distances are being discussed.

However, a thread or a reinforcement is said to be “radial” when the thread or reinforcing elements of the reinforcement form with the circumferential direction an angle greater than or equal to 80° and less than or equal to 90°. It should be specified that in this document the term “thread” should be interpreted in the broadest sense and comprises threads in the form of monofilaments, multifilaments, a cable, a yarn or an equivalent assembly, and this irrespective of the material of which the thread is made or the surface treatment carried out to promote its adhesion to the rubber.

Lastly, “radial section” here means a section taken in a plane containing the axis of rotation of the tire.

An “axial” direction is a direction parallel to the axis of rotation of the tire. A point P5 is said to be “axially inside” of a point P6 if it is closer than point P6 to the mid plane of the tire. Conversely, a point P7 is said to be “axially outside” of a point P8 if it is further than point P8 from the mid plane of the tire. The “mid plane” of the tire is that plane which is perpendicular to the axis of rotation of the tire and equidistant from the annular reinforcing structures of each bead.

A “circumferential” direction is a direction that is perpendicular both to a radius of the tire and to the axial direction. A “circumferential section” is a section in a plane perpendicular to the axis of rotation of the tire.

“Rolling surface” here means all those points on the tread of a tire that come into contact with the ground when the tire is rolling.

The expression “rubber compound” means a rubber composition containing at least an elastomer and a filler.

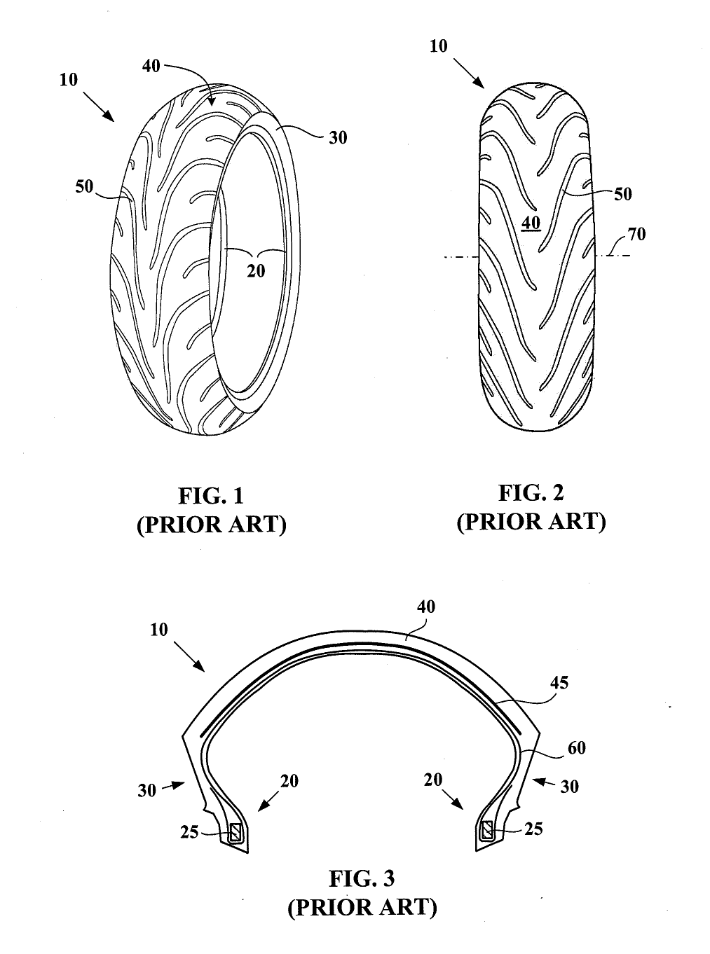

FIGS. 1 and 2 are diagrammatic views of a tire 10 according to the prior art, in this case a motorcycle tire. The tire 10 has a crown comprising a crown reinforcement (not visible in FIG. 1), on top of which is a tread 40, while two sidewalls 30 extend radially inwards from the crown, and two beads 20 lie radially inside of the sidewalls 30. The tread 40 comprises a plurality of grooves 50. The axis of rotation 70 of the tire is also indicated in FIG. 2, which shows the tire in a top view.

FIG. 3 shows diagrammatically in radial section half of a prior-art tire 10, again a motorcycle tire. The tire 10 has two beads 20 designed to come into contact with a wheel rim (not shown), each bead 20 having an annular reinforcing structure, in this case a bead wire 25. Two sidewalls 30 extend radially outwards from the beads 20 and meet in a crown comprising a crown reinforcement 45 comprising at least one reinforcing ply, on top of which in the radial direction is a tread 40. The tire 10 also has a carcass reinforcement 60 extending from the beads 20 through the sidewalls 30 to the crown. The carcass reinforcement 60 is anchored in each of the two beads 20 by a turn-up around the bead wire 25.

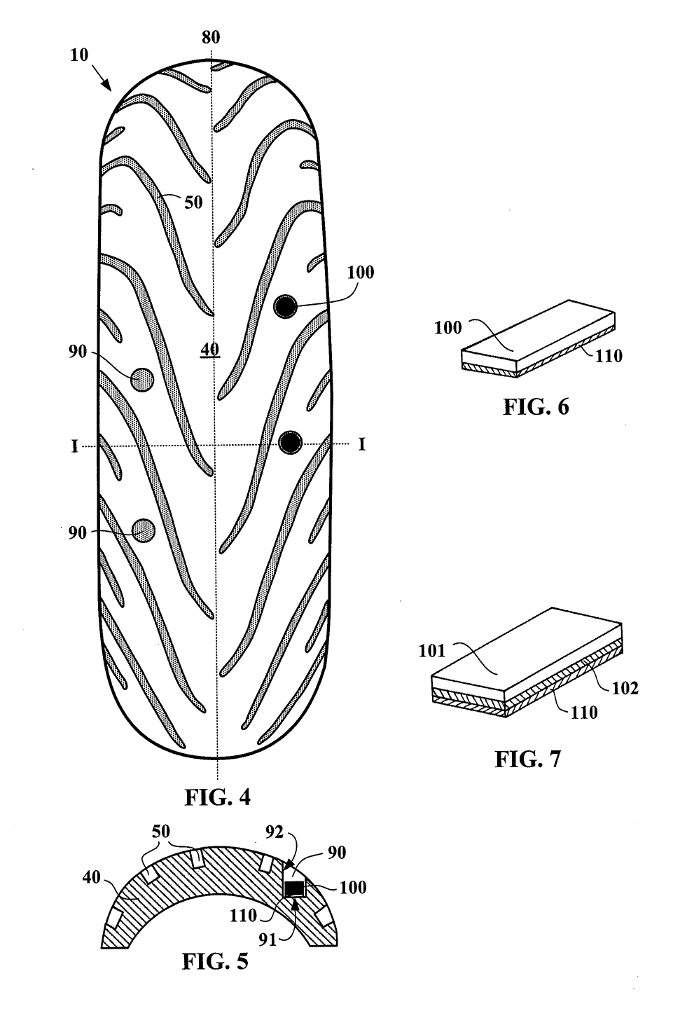

FIG. 4 shows diagrammatically, in a top view, the tread of a tire 10 according to the invention, before and after steps (A) and (B) of the method of the invention are carried out. FIG. 5 shows part of this tire 10 in a radial section taken on the axis indicated in FIG. 4.

The half of the tread 40 which is on the left of the axis 80 shows the tire as it appears before the method is carried out. The tread has grooves 50 and recesses 90. Each recess 90 is delimited by two walls: a cylindrical side wall 92 (see FIG. 5) opening onto the rolling surface, and a circular bottom wall 91 (see FIG. 5). The side wall 92 of the recess 90 is a “closed surface”: its intersection with the rolling surface of the tread is close to circular. In step (A), an appliqué 100 is inserted into the recess 90. The appliqué 100 covers 90% of the surface of the bottom wall, which maximizes its protective effect. In step (B), the appliqué is fixed by means of a layer of adhesive 110 to the wall forming the bottom of the recess, as shown on the half of the tread 40 visible to the right of the axis 80.

FIG. 6 shows diagrammatically a very simple appliqué 100 designed to be used in a method according to the invention. This kind of appliqué can be produced in a multitude of materials, such as elastic materials (silicones, rubber, etc.), textile materials, flexible or rigid microfoam materials, rigid materials (metals, PVC, etc.), leather, velvet, etc. The adhesive layer 110 is also shown.

A wide variety of adhesives can be used, examples being acrylic adhesives (such as cyanoacrylates), silicone adhesives, polyurethane adhesives (contact or non-contact), urethane adhesives, adhesives based on latex and adhesives based on natural rubber, hot melt adhesives, neoprene solvents, nitrile, SBR, etc.

It is of course also possible to use composite appliqués, such as the appliqué shown in FIG. 7. The appliqué shown comprises two layers 101 and 102. There could for example be a foam layer attached to a rigid layer, or an outer layer formed by a retro reflective strip (such as a strip of 3M™ Scotchlite™) attached to an inner layer of rubber giving good mechanical protection.

The tire 10 shown in FIG. 9 is a motorcycle tire. It has a circumferential groove 51 and recesses 52 which open at one side onto the sidewall 30 and the side wall of which is a quasi-closed surface. Appliqués 1002 have been bonded into these recesses. The tire also has recesses 90 the side wall of which is a closed surface. An appliqué 1001 has been fixed to the bottom wall of recess 90. It should however been noted that the invention is in no way limited to motorcycle tires.

As mentioned above, when determining whether the side wall of the recess is a closed surface, sipes opening into the recess are to be disregarded. In other words, it is not because there are such sipes that the sidewalls are considered not to be “closed surfaces” as defined above. As is well known to the skilled person, such sipes typically have a width of between 0.3 and 1.5 mm, measured along a direction perpendicular to the direction of their greatest dimension on the rolling surface of the tread. The presence of such sipes does not deteriorate the protection of the appliqué in the recess; it can even have positive effects. This situation is depicted in FIG. 9 wherein two sipes 141 and 142 open into the recess 90 provided in tread block 41. The air imprisoned within the recess, between the appliqué 100 and the ground, when the rolling surface surrounding the recess 90 comes into contact with the ground on which the tire is rolling, can escape through these sipes 141 an 142. This is advantageous in particular in view of the noise generated by the tire when it is rolling.

An example of a recess 90 having a “quasi-closed” side wall is shown in FIG. 10 which gives a top view of a tread block 41. The side wall of the recess has an intersection C (FIG. 11) with the rolling surface of the tread. Intersection C is an open curve with two endpoints C1 and C2. The straight line L connecting these endpoints C1 and C2 has a length that is about 40% of the maximum distance M between any two points of intersection C, measured parallelly to the straight line L.

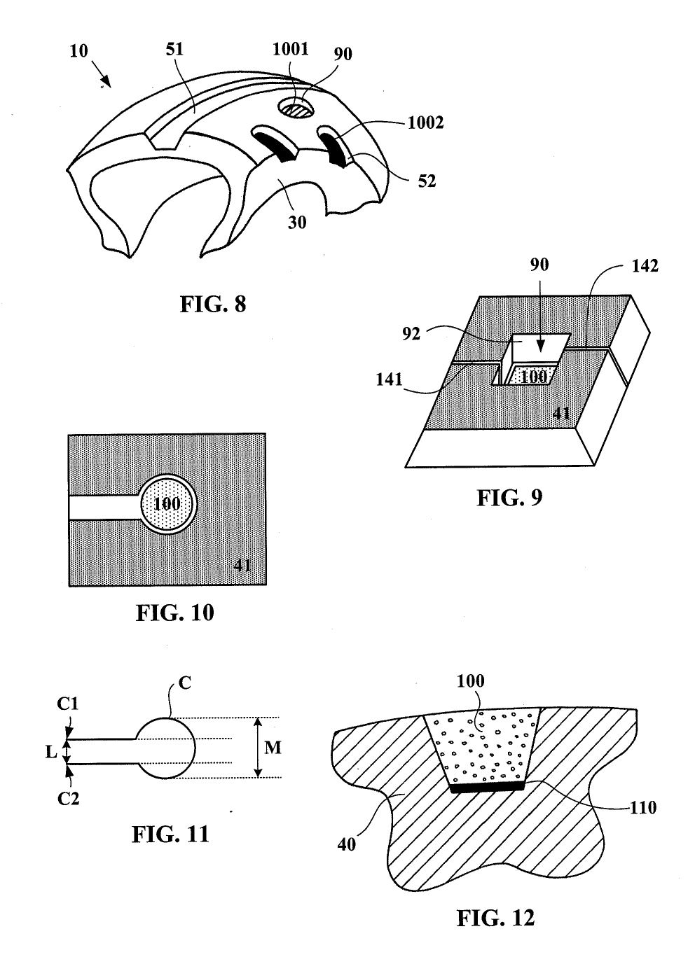

The appliqués shown in FIGS. 4, 5, and 8 to 10 do not project from the rolling surface: their thickness is such that the point or points forming their radially outermost extremities are radially inside of the rolling surface of the tread. This is not however an essential feature of the invention, as shown in FIG. 12, which shows diagrammatically, in a circumferential section, part of the tread of a tire according to the invention. The tread comprises a recess into which a foam appliqué 100 is bonded (the adhesive layer 110 can be seen) so that the appliqué fills the recess until it is flush with the rolling surface. In this way the appliqué would wear together with the tread 40.

1. A tire comprising a tread provided with a rolling surface, at least one recess being formed in the tread, which recess opens onto the rolling surface, the recess being delimited by a bottom wall and one single side wall, the tire also comprising at least one appliqué, and the appliqué being inserted into the recess and fixed by means of an adhesive to at least a portion of said bottom or side wall of the recess, wherein said side wall of the recess is a closed surface or a quasi-closed surface.

2. The tire according to claim 1, wherein the recess is fixed to at least a portion of said bottom wall.

3. The tire according to claim 1, wherein the appliqué covers at least 80% of the surface of the bottom wall.

4. The tire according to claim 1, wherein the radially outermost points of the appliqué are radially inside of the rolling surface of the tread.

5. (canceled)

6. The tire according to claim 1, wherein said side wall of the recess is a closed surface and wherein at least one sipe opens into the recess.

7. (canceled)

8. The tire according to claim 1, wherein the appliqué comprises at least a portion of a color other than black, this portion being visible from a viewpoint outside of the tread and facing the appliqué.

9. A method for making a tire more resistant to external aggression, the tire comprising a tread having a rolling surface and at least one recess opening onto the rolling surface, the recess being delimited by a bottom wall and one single side wall, wherein said side wall of the recess is a closed surface or a quasi-closed surface, comprising the following steps:
(A) inserting an appliqué into the recess; and
(B) fixing the appliqué is fixed by means of an adhesive to at least a portion of said bottom or side wall of the recess.

10. A kit for making a tire more resistant to external aggression according to the method of claim 9, the kit comprising at least one appliqué designed to be inserted into a recess in the tire tread, which recess opens onto the rolling surface, the recess being delimited by a bottom wall and a side wall, wherein said side wall of the recess is a closed-surface or a quasi-closed surface and wherein the kit also comprises a suitable adhesive for fixing the appliqué to at least a portion of said bottom or side wall of the recess.

11. The kit according to claim 10, wherein the kit also comprises a set of instructions describing steps (A) and (B) of the method of claim 9.
